(19) United States
(12) Patent Application Publication
(10) Pub. No.: US 2002/0122222 A1
(43) Pub. Date: Sep. 5, 2002

(54) Data path integrity in transparent OEO switch

(76) Inventors: Denis Gallant, Dunrobin (CA); Donald Asquin, Ottawa (CA)

Correspondence Address: MARKS & CLERK, P.O. BOX 957, STATION B, OTTAWA, ON, K1P 5S7, CA

(21) Appl. No.: 10/085,085

(22) Filed: Mar. 1, 2002

Related U.S. Application Data
(60) Provisional application No. 60/272,463, filed on Mar. 2, 2001.

(51) Int. Cl. H04B 10/08; H04J 14/00

(52) U.S. Cl. 359/110; 359/117

(57) ABSTRACT

This invention relates to a method for determining the integrity of the data signal across the switch fabric (ingress to egress of switch) and a method to select between the healthiest fabric planes in a redundant fabric system. Also, the invention provides a method of monitoring and reporting the functioning status of the back-up fabric plane at all times.

This invention claims the benefits of U.S. Provisional Application No. 60/272,463 filed Mar. 2, 2001.

### FIELD OF THE INVENTION

This invention relates to communications systems and more particularly to systems and methods of monitoring data path integrity in transparent optical-electrical-optical switching equipment for such systems.

### BACKGROUND

In communications networks, it is necessary to maintain data path integrity across the system to ensure proper data transfer. The common approach to data path integrity is to add or insert some overhead bits in the form of parity or CRC (Cyclic Redundancy Check) bits at ingress to the system, and extract these bits at egress to verify the data path integrity across the switching fabric. The drawbacks of these methods in a transparent OEO (Optical Electrical Optical) system are:

a) it requires knowledge of the data signal protocol and rate;

b) it requires more circuitry to terminate the data signal to insert and extract data integrity bits, increasing cost and complexity;

c) it requires clocking multiplier and de-multipliers to send extra bits across switching fabric, increasing cost and complexity.

In a transparent OEO switch, the switch is transparent or independent of the data signal protocol and data rate. In a transparent OEO switch, the ingress and egress line cards of the system do not insert or extract any overhead bits into the data signal.

### SUMMARY OF THE INVENTION

In view of the foregoing the present invention provides a method for determining the integrity of the data signal across the switch fabric (ingress to egress of switch) and a method to select between the healthiest fabric planes in a redundant fabric system. Also, the invention gives a method of monitoring and reporting on the functioning status of a back-up fabric plane at all times.

The methods described in this invention do not require that any overhead bits be inserted at ingress or that any bits be extracted from the data path signal at egress.

Therefore in accordance with a first aspect of the present invention there is provided a system for verifying path integrity through a transparent optical-electrical-optical (OEO) switch in a digital communications system comprising: an optical receiver at an ingress port of the switch to receive an optical data signal and to convert the optical data signal to an electrical data signal; a splitter to divide the electrical data signal into parallel paths for delivery to separate switch fabrics; data recovery units to receive data signals from the separate switch fabrics and to evaluate signal quality of respective paths; a processor to select one of the signals from the separate switch fabrics based on the evaluation; and a transmitter at an egress port to convert the one signal to an optical signal and to transmit the optical signal downstream.

In accordance with a second aspect of the invention there is provided a method of verifying integrity of a data signal through a transparent optical-electrical-optical switch in a digital communications system, the method comprising: receiving an optical data signal at an ingress port of the switch; converting the optical data signal to an electrical data signal; splitting the electrical signal into parallel paths and forwarding each through separate switch fabrics; evaluating signal quality of each signal from the separate switch fabrics; selecting the signal having the highest quality; converting the signal having the highest quality to an optical signal; and transmitting the selected optical signal downstream.

### BRIEF DESCRIPTION OF THE DRAWINGS

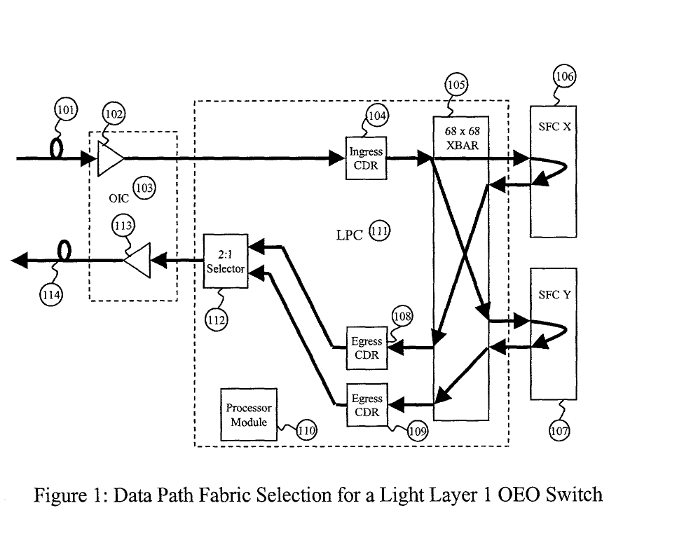

The invention will now be described in greater detail with reference to the attached drawing wherein FIG. 1 illustrates the data path of a simplified transparent OEO system.

### DETAILED DESCRIPTION OF THE INVENTION

FIG. 1 shows a simplified design of a transparent OEO switch for one data path of N data paths (the total number of data paths in the switch). The ingress optical fiber (101) carries the optical data signal to the photo detector (102) in the OIC (Optical Interface Card) (103). There, the optical data signal is converted to an electrical data signal, and is sent to the ingress CDR (Clock and Data Recovery) (104) on the LPC (Line Processing Card) (111). The data signal is then split into two streams in the 68×68 Crossbar (XBAR) (105) and routed to both of the redundant SFCs (Switch Fabric Cards) (106) and (107). Both data signals are routed to an egress CDR (108) and (109), then to the 2:1 selector (112) and finally to the laser transmitter (113) in the OIC (103). The processor module (110) controls the routing of the signals. Note that, for simplicity, the OIC (103) and LPC (111) are shown in FIG. 1 as single units; it is understood that multiple OICs and LPCs could be used and are still covered by this invention.

Both ingress CDR (104) and egress CDRs (108) and (109) are designed with built-in monitoring capabilities. In addition to the standard alarms for loss-of-signal and loss-of-lock, the CDRs can also monitor the data eye pattern opening. The processor module (110) monitors the state of the ingress CDR (104) and egress CDRs (108) and (109) for alarms and data eye pattern opening information. The processor module (110) can correlate data eye pattern opening to an equivalent bit error rate. How the CDRs (104), (108) and (109) and the processor module (110) correlate the data eye pattern opening information to an equivalent bit error rate is not the scope of this invention, but the fact that CDRs (104), (108) and (109) and processor module (110) are used to monitor the error performance of the redundant SFCs (106) and (107) is. The ingress CDR (104) and the processor module (110) inform the system of the error performance of the ingress data signal. The egress CDRs (108) and (109) and the processor module (110) inform the system of the error performance of the two SFCs (106) and (107). By comparing the data signal quality measurements of the two egress CDRs (108) and (109), the SFC (106) or (107) with the best error performance is chosen. The algorithm for determining the currently active data signal is not the subject of this invention, and may involve other parameters not discussed here. The processor module (110) programs the 2:1 selector (112) to pass the chosen data signal to the laser transmitter (113) on the OIC (103) for transmission over the egress fiber (114). The processor module (110) will also report, via alarm messages, any changes in the health of the data signals from the SFCs (106) and (107) to the main system control and management system.

While specific embodiments of the invention have been described and illustrated, it will be apparent to one skilled in the art that numerous changes can be made without departing from the basic concept. It is to be understood, however, that such changes will fall within the full scope of the invention as defined in the appended claims.

1. A system for verifying path integrity through a transparent optical-electrical-optical (OEO) switch in a digital communications system comprising:
an optical receiver at an ingress port of the switch to receive an optical data signal and to convert the optical data signal to an electrical data signal; a splitter to divide said electrical data signal into parallel paths for delivery to separate switch fabrics;
data recovery units to receive data signals from said separate switch fabrics and to evaluate signal quality of respective paths;
a processor to select one of said signals of said signals from said separate switch fabrics based on the evaluation; and
a transmitter at an egress port to convert said one signal to an optical signal and to transmit said optical signal downstream.

2. The system as defined in claim 1 wherein said data recovery units are clock data recovery (CDR) devices.

3. The system as defined in claim 2 wherein said CDR devices evaluate the bit error rate (BER) of said signals from said separate switch fabrics.

4. The system as defined in claim 2 wherein said CDR devices evaluate clock status of said signal from said separate switch fabrics.

5. The system as defined in claim 1 wherein said electrical signal is divided into two parallel paths and supplied to two separate switch fabrics.

6. The system as defined in claim 1 wherein said processor operates in conjunction with a selector to provide the signal having the highest quality to said transmitter.

7. A method of verifying integrity of a data signal through a transparent optical-electrical-optical switch in a digital communications system, the method comprising;
receiving an optical data signal at an ingress port of the switch; converting the optical data signal to an electrical data signal;
splitting the electrical signal into parallel paths and forwarding each through separate switch fabrics;
evaluating signal quality of each signal from said separate switch fabrics; selecting the signal having the highest quality;
converting the signal having the highest quality to an optical signal; and transmitting said optical signal downstream.
